(19) United States
(12) Patent Application Publication
(10) Pub. No.: US 2018/0191436 A1
(43) Pub. Date: Jul. 5, 2018

(54) POWER EFFICIENT VISIBLE LIGHT COMMUNICATION

(71) Applicant: QUALCOMM Incorporated, San Diego, CA (US)

(72) Inventors: Ravi Shankar Kadambala, Hyderabad (IN); Bapineedu Chowdary Gummadi, Hyderabad (IN); Vivek Veenam, Hyderabad (IN)

(21) Appl. No.: 15/394,499

(22) Filed: Dec. 29, 2016

(51) Int. Cl. H04B 10/116; G06T 7/246; G06T 7/73

(52) U.S. Cl. CPC H04B 10/116; H04M 1/72569; G06T 7/74; G06T 7/248

(57) ABSTRACT

Embodiments disclosed facilitate power and resource utilization efficiencies in User Equipment (UE) during Visible Light Communication (VLC). VLC may be used for UE pose determination and may involve image frame capture at relatively high frame rates thereby increasing resource utilization including power consumption in UEs. Disclosed embodiments determine a motion state of the UE during a first time period where a first plurality of image frames with VLC signals from at least one VLC source are captured with an image sensor. In some embodiments, VLC related functionality on the UE may be selectively disabled based on at least one of the determined motion state, and/or the determined usage of the one or more image frames.

### FIELD

This disclosure relates generally to apparatus and methods for power efficiency in devices and specifically to power efficiency in devices using Visible Light Communication.

### BACKGROUND

The increasing use of Light Emitting Diodes (LEDs) for lighting in a variety of environments has led to the use of Visible Light Communication (VLC) based signaling to communicate with user equipment (UE) such as cellular phones or other mobile devices. In VLC, communication may be effected by modulating visual light emitted by the LEDs. The modulation, which may be imperceptible to the human eye, is used to encode information, which can be demodulated and interpreted by processors on the UE. Modulated or encoded VLC signals may be used, for example, for positioning, navigation, and a variety of positioning related applications. Because light fixtures are widely prevalent in many environments, including indoor environments, VLC use can provide both lighting and communication. For example, VLC may be used to convey the position of a light fixture, which may then be used by a UE to determine its own position. VLC positioning accuracy can be better than 1 meter.

Typically, to process incoming VLC signals, an image sensor (e.g. photo sensor, CMOS sensor, camera, etc) may be active and continually processing VLC signals received from VLC sources. In mobile devices, which may have limited battery capacity, the reception and processing of these signals may detrimentally affect UE runtime and/or the battery recharge interval thereby limiting the practical applicability of VLC.

Therefore, there is a need for apparatus, systems, and methods to facilitate power efficient VLC.

### SUMMARY

According to some aspects, disclosed is a method for power efficient VLC communication on a mobile device. In some embodiments, a method on a User Equipment (UE) comprising an image sensor may comprise: capturing, during a first time period, a first plurality of image frames with the image sensor, the first plurality of image frames comprising Visible Light Communication (VLC) signals associated with at least one VLC source; determining a motion state of the UE during the first time period; determining a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and selectively disabling a VLC related functionality on the UE based on at least one of the determined motion state, or the determined usage of the one or more image frames.

In another aspect, an UE may comprise an image sensor coupled to a processor, wherein the processor is configured to: capture, during a first time period, a first plurality of image frames with the image sensor, the first plurality of image frames comprising Visible Light Communication (VLC) signals associated with at least one VLC source; determine a motion state of the UE during the first time period; determine a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and selectively disable a VLC related functionality on the UE based on at least one of the determined motion state, or the determined usage of the one or more image frames.

In a further aspect, disclosed embodiments pertain to a User Equipment (UE) comprising image sensing means, wherein the apparatus further comprises: means for capturing, during a first time period, a first plurality of image frames with the at least one image sensing means, the first plurality of image frames comprising Visible Light Communication (VLC) signals associated with at least one VLC source; means for determining a motion state of the UE during the first time period; means for determining a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and means for selectively disabling a VLC related functionality on the UE based on at least one of the determined motion state, or the determined usage of the one or more image frames.

Disclosed embodiments also pertain to non-transitory computer-readable media comprising executable instructions to configure a processor on a User Equipment (UE) with an image sensor to: capture, during a first time period, a first plurality of image frames with the image sensor, the first plurality of image frames comprising Visible Light Communication (VLC) signals associated with at least one VLC source; determine a motion state of the UE during the first time period; determine a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and selectively disable a VLC related functionality on the UE based on at least one of the determined motion state, or the determined usage of the one or more image frames.

Embodiments disclosed also relate to software, firmware, and program instructions created, stored, accessed, or modified by processors using computer readable media or computer-readable memory. The methods described may be performed on processors and various mobile devices.

These and other embodiments are further explained below with respect to the following figures. It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

Embodiments of the invention will be described, by way of example only, with reference to the drawings.

FIG. 1 shows a block diagram of an exemplary UE capable of VLC in a manner consistent with disclosed embodiments.

FIG. 2 shows an exemplary system illustrating a UE with VLC sources.

FIG. 3A shows an exemplary pipeline illustrating VLC signal processing.

FIG. 3B shows an exemplary waveform illustrating normal VLC processing.

FIG. 3C shows an exemplary waveform illustrating power and resource efficient VLC processing.

FIG. 4A shows a flowchart of an exemplary method for power efficient VLC signal processing.

FIG. 4B shows a flowchart illustrating an exemplary method of disabling VLC pose determination.

FIG. 5 shows a flowchart of an exemplary method for power efficient VLC signal processing.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

As used herein, the term “pose” refers to the position and orientation of a UE relative to a frame of reference. A 6 Degrees of Freedom (6 DoF) pose refers to three translation components (e.g. given by X, Y, and Z coordinates) and three angular components (e.g. roll, pitch and yaw). The pose of a UE may be expressed as a position or location, which may be given by (X, Y, Z) coordinates; and, an orientation, which may be given by angles (φ, θ, ψ) relative to the axes of the frame of reference. Thus, translational motion may refer to motion that induces a change in position, i.e. a change in at least one of the (X, Y, Z) translational coordinates, while rotational motion may refer to motion that induces a change in orientation, i.e. a change in at least one of the (φ, θ, ψ) angular coordinates. The term “pose determination” refers to the determination of both location and orientation (e.g. a 6 DOF pose). The terms “location determination” or “position determination” refer to the determination of positional coordinates (e.g. (X, Y, Z) translational coordinates). The term “orientation determination” refers to the determination or UE orientation (e.g. (φ, θ, ψ) angular coordinates). The term “stationary” refers to the absence of motion (e.g., no change in position or orientation).

A UE may experience translational motion, rotational motion, or a combination thereof. The term “motion state” is used to refer to characterizing motion of the UE such as whether the UE is: (i) stationary (no change to (X, Y, Z) or (φ, θ, ψ)); or (ii) has only rotational movement (changes to at least one of (φ, θ, ψ) without a change to (X, Y, Z)); or (iii) displacement (which may be linear (along a line), planar (on a plane), or 3-dimensional (3D)), without rotational movement (a change in at least one of (X, Y, Z) without a change in (φ, θ, ψ)) or (iv) both rotation and displacement (changes to at least one of (X, Y, Z) and a change to at least one of (φ, θ, ψ)).

Disclosed embodiments pertain to power efficient VLC signal processing on UEs. In some embodiments, the UE or processing circuitry (e.g. a Video Front End (VFE) or Image Signal Processor (ISP)) may be configured to selectively process VLC related image sensor data based on a motion state associated with the UE thereby reducing the volume of data processed. The term “VLC related” may refers to components, functionality, and/or applications on UE 100 that are used in the capture, and/or processing, and/or use of VLC signals. “VLC related image data” or “VLC related image sensor data” or “VLC related image frame” are used to refer to image information captured by image sensor 110 for VLC processing.

In some embodiments, by selectively processing of camera data, the UE may facilitate utilization of resources on the UE, which may result in power savings and/or increased availability of resources for other (e.g. non-VLC) applications on the UE. As one example, when the UE is stationary and the pose of the UE is known, t VLC based pose determination for the UE may be selectively disabled. In some embodiments, VLC based location determination may be resumed or activated when the motion state indicates a displacement of the UE. As another example, when the motion state of the UE indicates rotational motion without displacement, and the location of the UE is known, VLC based location determination for the UE may be selectively disabled. As a further example, the selective processing of VLC related image frames may occur, when VLC is being used for positioning operations and the speed of the UE is determined to not exceed a threshold. Further, in some embodiments, selective disabling of UE functionality may also be based on a determination of whether the UE is connected to a power source and/or (iii) a determination that the remaining or estimated battery capacity of the UE is below some threshold. In some embodiments, selective disabling of VLC related functionality may be triggered upon non-detection of a VLC source over some time period.

Selective disabling of VLC related functionality may include one or more of: disabling VLC signal demodulation; and/or disabling processing of one or more VLC frames, which may include disabling storage of one or more VLC frames; and/or disabling the image sensor (e.g. when not being utilized by another application). Demodulation refers to the process of extracting VLC signal information from the time varying carrier light signal. In some embodiments, motion state of the UE may be determined based on input from a motion sensor (e.g. accelerometers, gyroscopes, Inertial Measurement Unit (IMU), ultrasonic sensors, etc) on the UE; and/or movement of at least one VLC source relative to an image sensor on the UE; and/or based on the image sensors Field of View (FOV) of the light source(s); and/or feedback from a VLC decoder and/or an Image Signal Processor (ISP) (e.g. based on Computer Vision (CV) methods) indicating a change in pose of the UE. Activating VLC related functionality (e.g. upon detecting a change in motion state) may refer to initiating or re-starting VLC related functionality that may have been selectively disabled. “Activation” may refer to turning on or supplying power to a component (e.g. image sensor 110) that may have been turned off, changing the state of one or more components on UE 100 from a sleep, inactive, or low power state to an active state, and/or resuming the processing of signals and/or enabling VLC-related processing functionality.

In some embodiments, during UE motion, the time duration that a VLC source remains in a FOV of an image sensor on the UE may be related to distance of the VLC source from the UE. As one example, when there is an unimpeded line of sight to a VLC source and the distance between the light source and the device is high, then the VLC source may remain in the FOV of the image sensor for a longer duration during UE transverse motion relative to the VLC source. On the other hand, when the VLC source is at a shorter distance, then the VLC source may remain in the FOV of the image sensor for a shorter period during UE transverse motion relative to the VLC source. In some embodiments, VLC related functionality may be selectively disabled based on the determined distance to the VLC source and UE motion state over some time duration, which may determined based on UE pose changes.

Further, the placement of VLC source(s) within a field of view and the movement of the VLC sources across the field of view (FOV) or off of the field of view can be used to determine translational motion of the UE. Changes in orientation of the UE may be determined, for example, via accelerometers and/or gyros included in the UE. The orientation component (i.e., the orientation contribution to the overall movement of the VLC sources across the FOV) may be subtracted from the overall movement of VLC sources across a field of view, thereby determining the translational movement component via the remaining unattributed movement of the VLC sources across the field of view.

In some embodiments, normal VLC processing mode may be enabled (e.g. selective disabling may be suspended) when the user places an emergency call (e.g. 911 in the U.S.), or places a call to some designated numbers, and/or when a call from one or more designated numbers is received, and/or when one or more designated applications on the UE are invoked. An application may be any function on the UE, which may be implemented using software, or some combination of software and hardware.

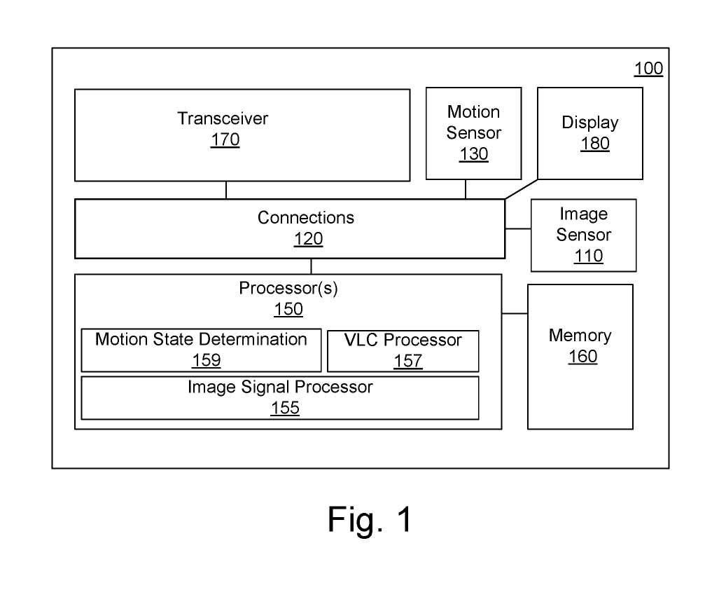

FIG. 1 shows a block diagram of an exemplary UE 100 capable of VLC in a manner consistent with disclosed embodiments. As used herein, UE 100, may take the form of a cellular phone, mobile phone, mobile device, or other wireless communication device, a personal communication system (PCS) device, personal navigation device (PND), Personal Information Manager (PIM), or a Personal Digital Assistant (PDA), a laptop, tablet, notebook and/or handheld computer. The terms UE, mobile device, or mobile station are used interchangeably herein.

In some embodiments, UE 100 may be capable of receiving VLC signals, wireless communication signals, and/or navigation signals. Further, the term UE is also intended to include devices which communicate with a personal navigation device (PND), such as by short-range wireless, infrared, wireline connection, or other connections regardless of whether VLC and/or position-related processing occurs at the device or at the PND.

The term UE is also intended to include gaming or other devices with VLC functionality that may not be configured to connect to a network or to otherwise communicate, either wirelessly or over a wired connection, with another device. For example, a UE may omit communication elements and/or networking functionality. For example, embodiments described herein may be implemented in a standalone device that is not configured to connect for wired or wireless networking with another device.

As shown in FIG. 1, UE 100 may include image sensor 110, motion sensor 130, processor(s) 150, memory 160 and/or transceiver 170, display/screen 180 which may be operatively coupled to each other and to other functional units (not shown) on UE 100 through connections 120. Connections 120 may comprise buses, lines, fibers, links, etc., or some combination thereof.

Transceiver 170 may, for example, include a transmitter enabled to transmit one or more signals over one or more types of wireless communication networks and a receiver to receive one or more signals transmitted over the one or more types of wireless communication networks. Transceiver 170 may permit communication with wireless networks based on a variety of technologies such as, but not limited to, femtocells, Wi-Fi networks or Wireless Local Area Networks (WLANs), which may be based on the IEEE 802.11x family of standards, Wireless Personal Area Networks (WPANs) such Bluetooth, Near Field Communication (NFC), networks based on the IEEE 802.15x family of standards, etc, and/or Wireless Wide Area Networks (WWANs) such as LTE, WiMAX, etc. In some embodiments, UE 100 may also include one or more ports for communicating over wired networks.

In some embodiments, UE 100 may comprise image sensor 110. The term “image sensor” is used to refer to a broad array of sensors, including such as CCD or CMOS sensors, photo sensors, photo diodes, optical sensors, and/or camera(s) which are hereinafter referred to as “image sensor 110”. In some embodiments, image sensor 110 may comprise a camera with a rolling shutter. The term “rolling shutter” refers to image capture by rapid scanning of a scene. The scanning may be vertical (column by column) or horizontal (line by line). Image sensor 110 may capture image frames with modulated light signals such as VLC signals and send the image frames to processor(s) 150. In some embodiments, image sensor 110 may convert an optical image into an electronic or digital image and may send captured images to processor(s) 150.

In some embodiments, image sensors 100 may capture VLC signals. In VLC, VLC sources (e.g. LED light fixtures) may broadcast positioning signals using rapid modulation of light output level in a manner that does not affect the illumination provided. The positioning signals may be received by UE 100 through image sensors 110 and may be used to compute the UEs pose. VLC signals transmitted by each VLC source may include a unique identifier which identifies the VLC source.

In some embodiments, a map of locations of VLC sources and their identifiers may be stored on a remote server. In some embodiments, UE 100 may download and/or receive the VLC map and VLC identifiers as location assistance data (e.g. from the remote server). The location assistance data may be used by UE 100 along with VLC identifiers and corresponding VLC signal measurements to determine a pose of UE 100.

For example, in some embodiments, image sensors 110 and/or processor(s) 150 may be also be capable of determining an Angle of Arrival (AoA) of incoming light from a VLC source. In some embodiments, image sensor 110 may be capable of spatially separating distinct VLC sources and capturing signals from the sources simultaneously. In some embodiments, based in part, on corresponding Angles of Arrival from one or more VLC sources, and information in the corresponding received VLC signals, a pose of UE 100 may be determined (e.g. by processor(s) 150). In some embodiments, measurements of VLC signals such as Received Signal Strength (RSS), Time of Arrival (ToA), Time Difference of Arrival (TDOA), Phase of Arrival (PoA), Phase Difference of Arrival (PDoA) may also be used to facilitate UE pose determination.

The pose of image sensor 110 refers to the position and orientation of the image sensor 110 relative to a frame of reference. In some embodiments, the pose of the image sensor may be used as a proxy for the pose of the UE 100. In some embodiments, the pose of UE 100 may be determined based on the pose of image sensor 110. In some embodiments, the pose of image sensor 110 and/or UE 100 may be determined and/or tracked by processor(s) 150 using an image based tracking solution based on images captured by image sensor 110. For example, Image Signal Processor (ISP) 155 may implement and execute VLC or Computer Vision (CV) based positioning to determine a pose of UE 100. In some embodiments, pose may determined based on information in VLC signal measurements (e.g. unique identifier of the VLC source) and information obtained from received VLC signals such as AoA. The Angle of Arrival is the angle between the propagation direction of a light wave from a VLC source incident on an image sensor and a reference direction or a frame of reference axis. In some embodiments, the pose of the image sensor 110 may be used as proxy for the pose of the UE 100. In some embodiments, a pose of UE 100 may be determined based on a known positional or geometric relationship between image sensor 110 and UE 100.

In some embodiments, processor(s) 150 may also receive input from motion sensor 130. In some embodiments, motion sensor 130 may comprise an Inertial Measurement Unit (IMU), which may include 3-axis accelerometer(s), 3-axis gyroscope(s), and/or magnetometer(s). Motion sensor 130 may provide speed, orientation, and/or other motion state information to processor(s) 150. In some embodiments, motion sensor 130 may comprise an ultrasonic sensor, which may determine movement of UE 100. In some embodiments, motion sensor may comprise a pedometer. In some embodiments, motion sensor 130 may output measured information in synchronization with the capture of each image frame by image sensor 110. In some embodiments, the output of motion sensor 130 may be used in part by processor(s) 150 to determine a motion state of UE 100.

In some embodiments, processor(s) 150 and/or motion state determination processor (MSDP) 159 may determine a motion state of UE 100 based on inputs from one or more of: motion sensor 130, image sensor 110, ISP 155, and/or VLC processor 157. For example, a speed of UE 100 may be determined by processor(s) 150 and/or MSDP 159 based on pose changes. Pose changes may be determined based on VLC signals in images captured by image sensor 110, and/or input from motion sensor 130.

Image sensor 110 may comprise a plurality of cameras and include color or grayscale cameras. The term “color information” as used herein refers to color and/or grayscale information. In general, as used herein, a color image or color information may be viewed as comprising 1 to N channels, where N is some integer dependent on the color space being used to store the image. For example, an RGB image comprises three channels, with one channel each for Red, Blue and Green information.

In some embodiments, UE 100 may comprise multiple image sensors 110, such as dual front cameras and/or a front and rear-facing cameras, which may also incorporate various sensors. In some embodiments, image sensor 110 may be capable of capturing both still and video images. In some embodiments, image sensor 110 may be RGB video cameras capable of capturing images at appropriate frame rates (e.g. based on a selected video mode). In one embodiment, images captured by image sensor 110 may be in a raw uncompressed format and may be processed prior to being stored in memory 160.

Images captured by image sensor 110 may be used for one or more of VLC based pose determination for the UE, or VLC based communication/demodulation of signals from one or more VLC sources, or a non-VLC related application (e.g. video capture or an application involving image capture) on the UE. In some embodiments, VLC related processing may be performed by one or more of processor(s) 150, ISP 155, VLC processor 157 and/or MSDP 159.

Further, UE 100 may include a screen or display 180 capable of rendering color images, including 3D images. In some embodiments, display 180 may be used to display live images captured by image sensor 110, Augmented Reality (AR) images, Graphical User Interfaces (GUIs), program output, etc. In some embodiments, display 180 may comprise and/or be housed with a touchscreen to permit users to input data via some combination of virtual keyboards, icons, menus, or other Graphical User Interfaces (GUIs), user gestures and/or input devices such as styli and other writing implements. In some embodiments, display 180 may be implemented using a Liquid Crystal Display (LCD) display or a Light Emitting Diode (LED) display, such as an Organic LED (OLED) display.

In other embodiments, display 180, image sensor 110, and/or motion sensor 130 may form part of a wearable portion of UE 100. The wearable portion(s) of UE 100 may be operationally coupled to, but housed separately from, other functional units in UE 100.

Not all functional units comprised in UE 100 have been shown in FIG. 1. Exemplary UE 100 may also be modified in various ways in a manner consistent with the disclosure, such as, by adding, combining, or omitting one or more of the functional blocks shown. For example, in some configurations, UE 100 may not include transceiver 170. Further, in certain example implementations, UE 100 may include a variety of other sensors (not shown) such as an ambient light sensor, microphones, acoustic sensors, laser range finders, etc. In some embodiments, portions of UE 100 may take the form of one or more chipsets, and/or the like.

Processor(s) 150 may be implemented using a combination of hardware, firmware, and software. The term “processor(s)” may also refer to circuitry comprising one or more one of: ISP 155, VLC processor 157, and/or MSDP 159. In some embodiments, processor(s) 150 may comprise one or more of: ISP 155, VLC processor 157, and/or MSDP 159. Processor(s) 150 may represent one or more circuits configurable to perform at least a portion of a computing procedure or process related to wireless communication including VLC signal processing and/or communication, VLC based pose determination, and/or other processing functions. Processor(s) 150 may also be configurable to perform at least a portion of a computing procedure or process related to image processing, motion state determination and detection, selective disabling of VLC related functions on UE 100, etc. Processor(s) 150 may retrieve instructions and/or data from memory 160 to perform the functions outlined herein.

Processor(s) 150, ISP 155, VLC processor 157, and/or MSDP 159 may be implemented using one or more application specific integrated circuits (ASICs), central and/or graphical processing units (CPUs and/or GPUs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic components, or a combination thereof designed to perform the functions described herein.

Memory 160 may be implemented within processor(s) 150 and/or external to processor(s) 150. As used herein the term “memory” refers to any type of long term, short term, volatile, nonvolatile, or other memory and is not to be limited to any particular type of memory or number of memories, or type of physical media upon which memory is stored. In some embodiments, memory 160 may hold program code that facilitates one or more image processing, motion determination and/or detection, tracking, VLC signal processing/communication, selective disabling of VLC related functionality on UE 100, and other tasks performed by on processor(s) 150, ISP 155, VLC processor 157, and/or MSDP 159. For example, memory 160 may hold program code, data, captured still images, depth information, video frames, program results, as well as data provided by motion sensor 130 and other sensors. In general, memory 160 may represent any data storage mechanism. Memory 160 may include, for example, a primary memory and/or a secondary memory. Primary memory may include, for example, a random access memory, read only memory, etc. While illustrated in FIG. 1 as being separate from processor(s) 150, it should be understood that all or part of a primary memory may be provided within or otherwise co-located and/or coupled to processor(s) 150.

Secondary memory may include, for example, the same or similar type of memory as primary memory and/or one or more data storage devices or systems, such as, for example, flash/USB memory drives, memory card drives, disk drives, optical disc drives, tape drives, solid state drives, hybrid drives etc. In certain implementations, secondary memory may be operatively receptive of, or otherwise configurable to couple to a non-transitory computer-readable medium in a removable media drive (not shown) coupled to UE 100. In some embodiments, non-transitory computer readable medium may form part of memory 160 and/or processor(s) 150.

In some embodiments, ISP 155 may implement various computer vision methods and/or process images captured by image sensor 110. For example, ISP 155 may be capable of processing one or more images captured by image sensor 110 to determine a pose or position of UE 100. In some embodiments, processor(s) 150 may selectively disable ISP 155 and/or one or more functions provided by ISP 155. For example, when a pose of UE is known, based on the motion state of UE 100 (e.g. determined based on input from motion sensor 130), processor(s) 150 may selectively disable VLC related image frame demodulation and/or processing.

In some embodiments, VLC processor 157 may process images captured by image sensor 110 to demodulate and decode VLC signals (e.g. to determine an identifier associated with one or more VLC sources). Further, processor(s) 150, VLC processor 157, and/or ISP 155 may be capable of processing the received VLC information and/or measured information (e.g. AoA, TOA, TDOA, POA, PDOA etc.) to determine a pose of UE 100.

In some embodiments, ISP 155 may obtain a sequence of frames from image sensor 110. Each frame may be an N×M matrix of pixel values, where the n^{th} row and m^{th} column pixel value is denoted by P_nm. In some embodiments, ISP 155 may identify a subset of the pixel array where the source of the VLC signal is visible. This region may be referred to as the Field of View (FOV) of the ISP.

The FOV is typically characterized by a larger SNR than the rest of the image. In some embodiments, ISP 155 may identify the image region corresponding to the FOV by identifying pixels that are brighter than other pixels. For example, the receiver may identify pixels with a luma (brightness) value that is greater than a threshold L. In some embodiments, pixels with a luma greater that L may be considered part of the FOV. In some embodiments, the threshold L may be set to 50% of the average luma value for the image.

In some embodiments, based on the input provided by one or more of: ISP 155, or VLC processor 157, or motion sensor 130, MSDP 159 may determine a motion state of UE 100. For example, MSDP 159 may determine a motion state based on: (a) input by an IMU, accelerometer, gyroscope, and/or (b) based on the FOV; and/or (c) or relative motion of the light source with respect to image sensor 110; and/or (c) feedback or input from VLC processor 157 and/or ISP 155. The feedback may indicate that UE motion does not exceed some threshold. The motion state may indicate that UE 100 is stationary, undergoing displacement without rotation, undergoing rotation without displacement, or undergoing some combination of rotational and translational movement.

In conventional VLC communication methods, VLC signals are continuously captured and processed by the UE. The VLC signals may be processed by demodulating the signals, identifying VLC sources, and using VLC measurements (e.g. AoA) for pose determination. The continuous acquisition and processing of VLC signals may consume limited battery resources on UEs, increase processing overhead, increase system bus contention, increase the frequency of recharging, and decrease processor and resource availability for other applications on UE 100.

In some embodiments disclosed herein, VLC processing may be selectively disabled based on a motion state of the UE. For example, in some embodiments, when the pose of the UE is already known and the motion state indicates that UE 100 is stationary, VLC signal processing for UE pose determination may be disabled. In some embodiments, for example, when the pose of the UE 100 is known and the motion state indicates that UE 100 is undergoing rotational movement without displacement, VLC based location determination may be disabled. In some embodiments, when the pose of the UE is already known and the motion state indicates that UE 100 is stationary, image sensor 110 may be disabled, when image sensor 110 is not being utilized by another VLC related (e.g. for communication) and/or non-VLC related application (e.g. video capture) on UE 100.

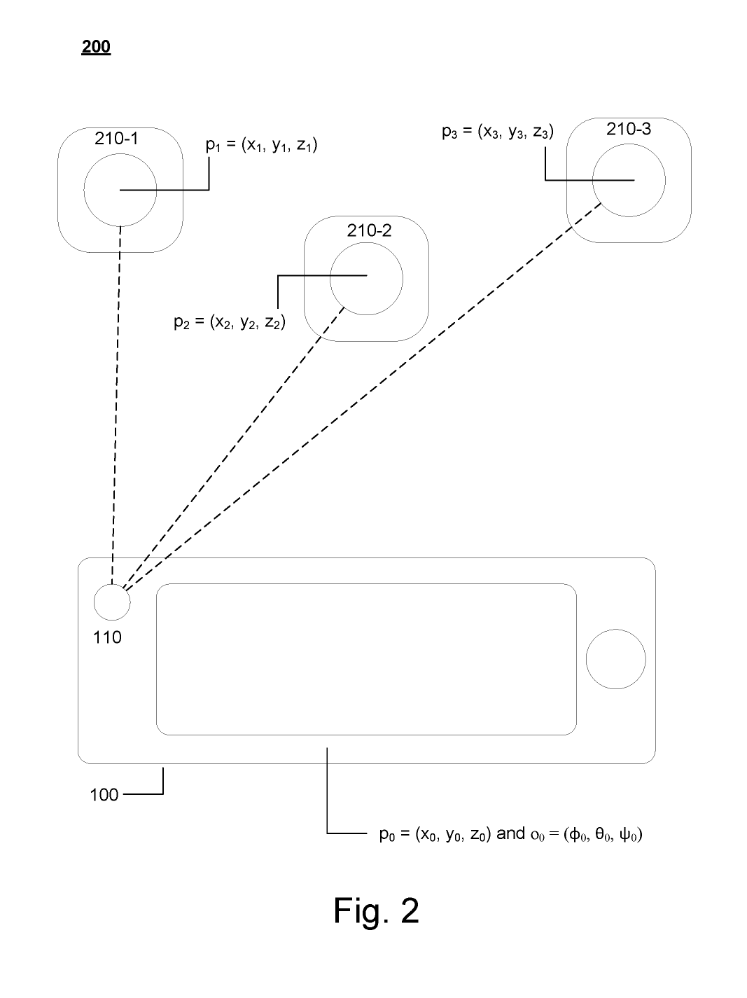

FIG. 2 shows an exemplary system 200 showing a UE 100 with VLC sources 210-1, 210-2, and 210-3. As shown in FIG. 2, image sensor 110 on UE 100 may receive VLC signals from VLC sources 210-1 at position ₚ₁=(ₓ₁, _{y1}, _{z1}), 210-2 at position ₚ₂=(ₓ₂, _{y2}, _{z2}), and 210-3 at position ₚ₃=(ₓ₃, _{y3}, _{z3}). For example, VLC sources 210 may be LED lights. Light from VLC sources 210 may be modulated to encode information. In some embodiments, the information encoded in VLC signals corresponding to each VLC source may comprise: synchronization, initialization, or other handshaking information, identifying information for the corresponding VLC source, and various other types of data. The VLC information from each VLC source may demodulated and decoded by UE 100 (e.g. using processor(s) 150 and/or VLC processor 157). For example, based on VLC source identification information in received VLC signals and other measured parameters (e.g. AoA), UE 100 may determine its pose comprising a position p₀=(x₀, y₀, z₀) and an orientation o₀=(φ₀, θ₀, ψ₀) relative to a frame of reference. In some embodiments, the position information and identifying information for VLC sources 210-1, 210-2, and 210-3 may be received by UE 100 as part of VLC location assistance data.

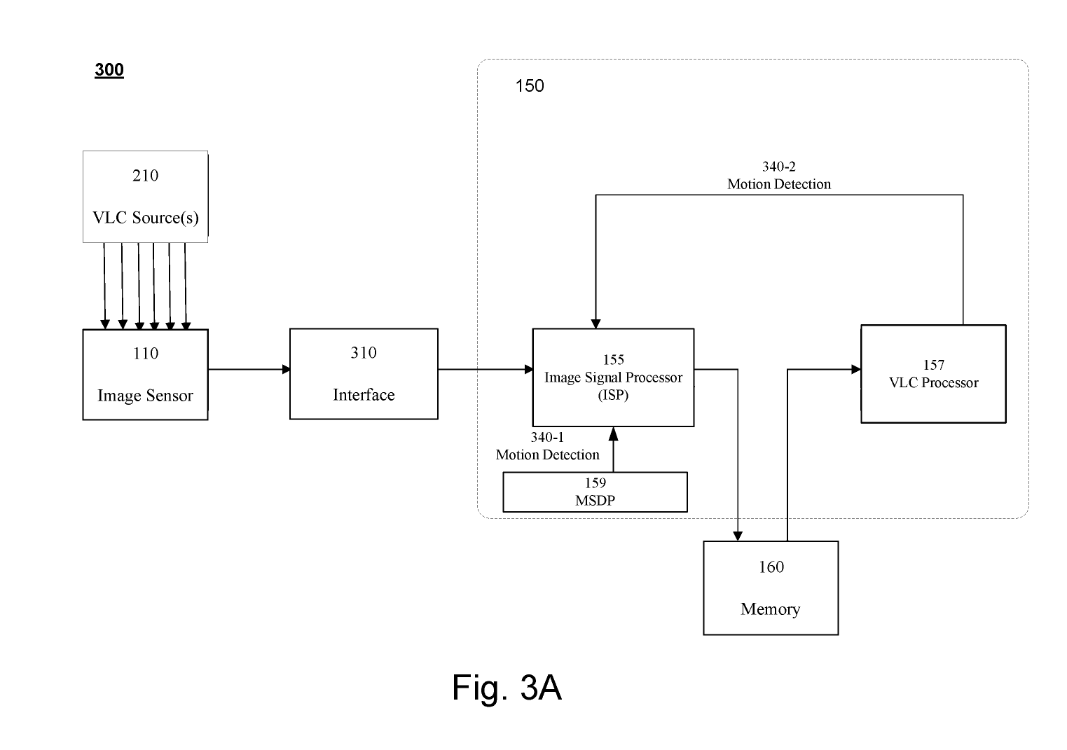

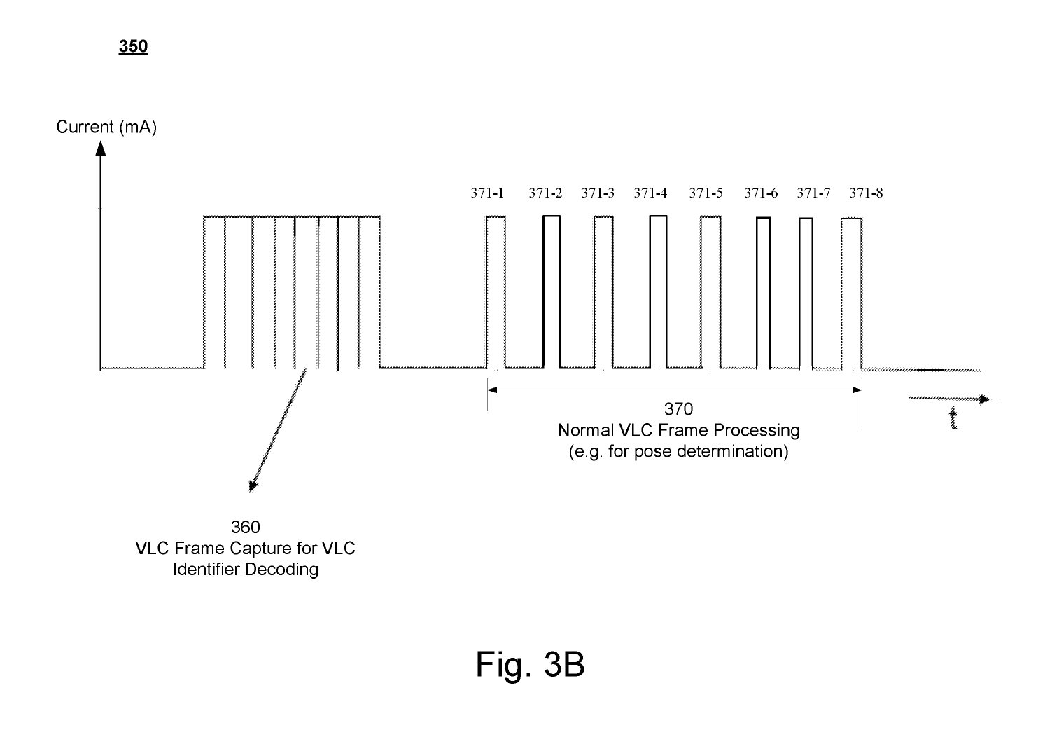

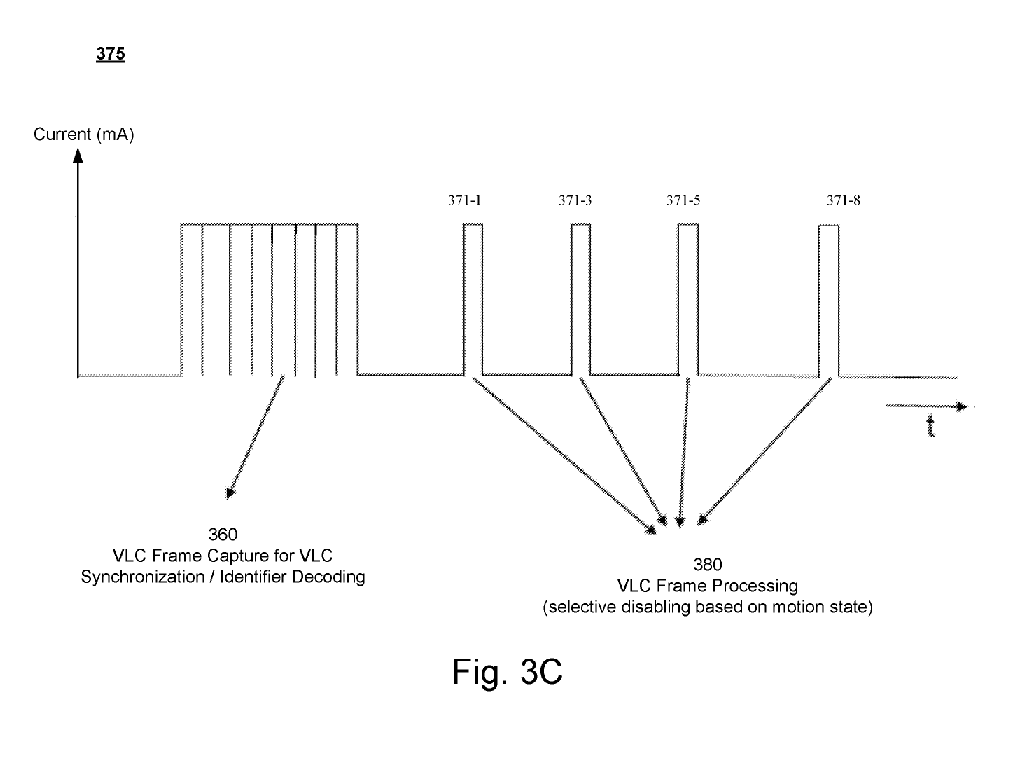

FIG. 3A shows an exemplary pipeline 300 illustrating VLC signal processing. As shown in FIG. 3A, VLC source(s) 210 may modulate light signals, and the VLC signals may be received by image sensor 110. In some embodiments, image sensor 110 may comprise a mobile camera with a rolling shutter, which may read data line by line. Image sensor 110 may run at a high frame rate (e.g. 240 fps) to capture VLC data. Because video cameras (or image sensors capturing frames for video applications) typically run at much lower frame rates (e.g. 30 fps), VLC data processing may write substantially more data to memory (e.g. 240 frames per second) and consume more system resources (e.g. increase utilization of the system bus). The frame rates indicated above are merely exemplary and higher or lower frame rates may be used depending on the modulation, desired VLC bandwidth, and other system parameters.

Image frames captured by image sensor 110 may be sent to ISP 155 through interface 310. Interface 310 may be any interface that allows signal transmission from image sensor 110 to ISP 155. In some embodiments, interface 310 may be a Mobile Industry Processing Interface (MIPI). MIPI is a set of standards published by an organization known as the MIPI alliance. MIPI standards define signaling characteristics between processors and peripherals such as image sensor 110.

In instances where image sensor 110 comprises a rolling shutter camera with line by line output, ISP 155 may compose or create an image frame structure from the received lines and write the image frame to memory. In some embodiments, the image frame may also be sent to VLC processor 157, or read by VLC processor 157 from memory 160. In some embodiments, ISP 155 and VLC processor 157 may form part of processor(s) 150. ISP 155 and/or VLC processor 157 may be digital signal processors, ASICs, or embedded processors capable of processing VLC signals. ISP 155 and/or VLC processor 157 may be implemented using some combination of hardware, software and/or firmware.

Because the lines obtained by image sensor 110 are structured into an image frame by ISP 155, which is then written to memory 160 (e.g. over a bus/connections 120) before being sent to VLC decoder, in some conventional UEs, ISP 155 may consume power and other resources when VLC signals are being processed. Since conventional techniques process VLC frames continually, VLC processing may deplete the battery, increase memory bus and/or system bus utilization and/or contention, reduce available memory, and limit the availability of ISP for other tasks.

In some embodiments, ISP 155 may receive motion state detection signal 340, which may include an indication of the motion state of UE 100. For example, ISP 155 may receive motion state detection signal 340-1 from MSDP 159 and/or motion state detection signal 340-2 from VLC processor 157. In some embodiments, motion state detection signal 340 may indicate motion related characteristics of UE 100. For example, motion state detection signal 340 may indicate whether UE is stationary, undergoing rotational movement only (without displacement), undergoing displacement only (no rotation), or some combination of rotation and displacement. In some embodiments, motion state detection signal 340 may indicate whether a speed of UE 100, and/or whether UE 100 is moving at a speed above some threshold.

Accordingly, in some embodiments, if the pose of UE is known and when the motion state of UE 100 indicates that UE 100 is stationary, then, (a) then VLC pose determination may be disabled if image sensor 110 is not being utilized for VLC communication and/or for non-VLC related purposes. In some embodiments, image sensor 110 may be disabled by being switched off, made inactive, or placed in a sleep or low power state. In some embodiments, when the motion state of UE 100 indicates that UE 100 is moving below some speed, then, the processing of one or more frame of VLC data received from image sensor 110 may be reduced (e.g. processing of one or more VLC frames may be skipped).

For example, when video is being captured for non-VLC related purposes and motion state detection signal 340 indicates that UE 100 is either stationary, or moving below some speed, then the processing of one or more VLC frames may be skipped and processing may occur at the normal video frame rate (e.g. 30 fps instead of 240 fps). In embodiments where a rolling shutter is used with image sensor 110, ISP 155 may stop processing lines for skipped frames. Accordingly, when the motion state of UE 100 indicates that UE 100 is stationary, or moving at a speed below some threshold, one or more captured frames may not be written to memory or sent to VLC processor 157. In some embodiments, the number of frames skipped may increase as the speed decreases when the speed of UE 100 does not exceed the threshold. Conversely, as speed of UE 100 increases the number of frames skipped may decrease. In some embodiments, normal VLC processing (e.g. no skipped frames) may resume when speed exceeds the threshold. In some embodiments, the speed below the threshold may be divided into ranges and the number of VLC frames to be skipped may be set for each range.

In some embodiments, MSDP 159 may receive input from motion sensor 130 and/or other processors (e.g. ISP 155 and/or processor(s) 150), and may generate motion state detection signal 340 based on the input from motion sensor 130 and/or processor(s) 150. In some embodiments, MSDP 159 may also receive motion input or position input from a wearable device or a proximate device (e.g. a pedometer, smartwatch, activity tracker, headset, etc) to which UE 100 may be coupled (e.g. through a WPAN). The motion or position input may be used by MSDP 159 to generate motion detection signal 340.

In some embodiments, motion state detection signal 340 may include an indication that UE is: (a) stationary, (b) experiencing rotational motion without displacement, or (c) undergoing displacement without rotational motion, or (d) both displacement and rotation. In some embodiments, motion state detection signal 340 may further include an indication of the speed of movement of UE 100, an angular velocity (for rotational motion), and/or other metrics related to pose changes and/or the motion state.

In some embodiments, ISP 155 may also receive motion detection signal 340-2 as feedback from VLC processor 157. For example, VLC processor 157 may process VLC data in VLC image frames that are processed to determine a change in position over some time period and provide an indication of the motion state of UE 100 to ISP 155. Accordingly, based, in part, on the motion state, VLC signal processing on UE 100 may be selectively disabled. In some embodiments, the selective disabling of VLC signal processing may be based further on whether: (a) VLC signals are currently being used for non-pose determination functions; and/or (b) captured image frames are being used for non-VLC functions; and/or (c) connection of UE 100 or proximity of UE 100 to a power source; and/or (d) available battery capacity on UE 100. In some embodiments, UE 100 may be transitioned from a mode where VLC signal processing is selectively disabled to normal VLC processing mode when the motion detection signal 340 indicates a change in the motion state of UE 100.

In some embodiments, UE 100 may be kept in normal VLC processing mode or prevented from selectively disabling of VLC signal processing when UE 100 is being used for emergency related functions and/or other specified functions. In some embodiments, UE 100 may be transitioned from a mode where VLC signal processing is selectively disabled to normal VLC processing mode when an emergency call is initiated and/or one or more other specified functions on UE 100 are invoked.

FIG. 3B shows an exemplary waveform 350 illustrating normal VLC processing. In FIG. 3B the horizontal axis represent time (t) and the vertical axis represents current in milli-amperes (mA). Each pulse in waveform 360 may represent a VLC image frame processing event. Thus, the current spikes or pulses in FIG. 3B are indicative of the power consumed for VLC processing.

As shown in FIG. 3B, VLC processing may comprise a synchronization/VLC Identifier decoding phase 360, where a number of VLC image frames may be captured for synchronization with a VLC source 210 and/or to decode an identifier for the corresponding VLC source.

In some embodiments, VLC processing may also comprise phase 370, where VLC frames are processed by UE 100 to determine its pose (e.g. by measuring AoA etc). For example, as shown in FIG. 3B, VLC frames 371-1, 371-2, 371-3, 371-4, 371-5, 371-6, 371-7, and 371-8 are processed during phase 370. Phase 370 shown in FIG. 3B may represent normal VLC frame processing.

FIG. 3C shows an exemplary waveform 375 illustrating power and resource efficient VLC processing. In FIG. 3C the horizontal axis represent time (t) and the vertical axis represents current in milli-amperes (mA). Each pulse in waveform 375 may represent a VLC image frame processing event. Thus, the current spikes or pulses in FIG. 3C are indicative of the power consumed for VLC processing.

As shown in FIG. 3C, VLC processing may comprise a synchronization/VLC Identifier decoding phase 360, where a number of VLC image frames may be captured for synchronization with a VLC source 210 and/or to decode an identifier for the corresponding VLC source. In some embodiments, for example, when periodic synchronization with a VLC source 210 and/or VLC source identification is to be performed, either: (a) VLC frame processing may be performed normally during the synchronization period or (b) any selective disabling of VLC signal processing during synchronization may be set to ensure that synchronization is not affected. Thus, as shown in FIG. 3C, during synchronization/VLC Identifier decoding phase 360, VLC frame processing may proceed normally.

In some embodiments, VLC processing may also comprise phase 380, where VLC frame processing may be selectively disabled based, in part, on the motion state of UE 100. In some embodiments, based on the motion state of UE 100, one or more VLC related frames may not be processed. For example, the VLC related frames may not be stored in memory 160, and/or sent to VLC processor 157. In FIG. 3C, for example, VLC frames 371-2, 371-4, 371-6, and 371-7 are not processed during phase 380.

In some embodiments, motion state may indicate that UE is: (a) stationary, (b) experiencing rotational motion without displacement, or (c) undergoing displacement without rotational motion, or (d) both displacement and rotation. In some embodiments, motion state detection signal 340 may further include an indication of the speed of movement of UE 100, an angular velocity (for rotational motion), and/or other metrics related to pose changes and/or the motion state. As one example, if the pose of UE 100 is known prior to phase 380 and the motion state of UE 100 is determined as stationary (e.g. via motion detection signal 340), then, in Phase 380, the processing of one or more VLC related frames for pose determination may be disabled. As another example, when motion state information is provided based on the VLC processing (e.g. via motion detection signal 340-2), then, in Phase 380, the processing of one or more VLC related frames used for pose determination may be disabled for some time duration and then resumed to determine if there has been a change in motion state. For example, in an office environment, where a UE has been placed on a desk by a user and is stationary, significant power savings and resource utilization efficiencies may accrue from selective disabling of VLC related processing.

In some embodiments, such as where UE 100 is stationary and images are not being captured for other functions, image sensor may be turned off for some period, or until a change in motion state. In some embodiments, the selective disabling of VLC related processing may be stopped or modified in response to a change in the motion state of UE 100.

FIG. 3C merely illustrates one exemplary embodiment and various other scenarios for selectively disabling VLC frame processing are envisaged. As another example, if the pose of UE 100 is known prior to phase 380 and the motion state of UE 100 is determined as rotational movement without displacement (e.g. via motion detection signal 340), then, in Phase 380, position determination functions on UE 100 from processing VLC frames may be disabled, while orientation determination may continue. As a further example, if the pose of UE 100 is known prior to phase 380 and the motion state of UE 100 is determined as displacement without rotation (e.g. via motion detection signal 340), then, in Phase 380, orientation determination functions on UE 100 from processing VLC frames may be disabled, while position determination may continue. As another example, if the speed (displacement) or angular velocity is below some threshold, then selective disabling of VLC related processing may be triggered.

As shown in FIG. 3C, power savings may result from not processing one or more VLC related frames. In addition, not processing VLC related frames 371-2, 371-4, 371-6, and 371-7 may result is lower bus utilization, lower bus contention, and may free up resources for use by other applications on UE 100.

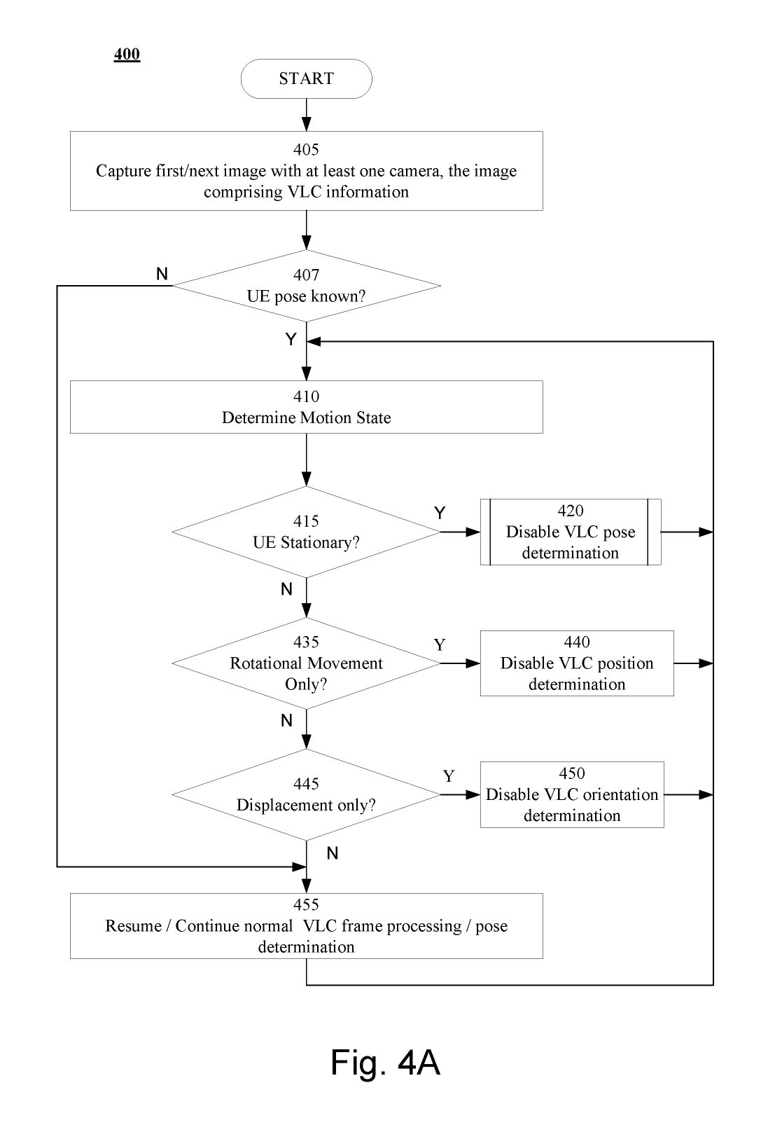

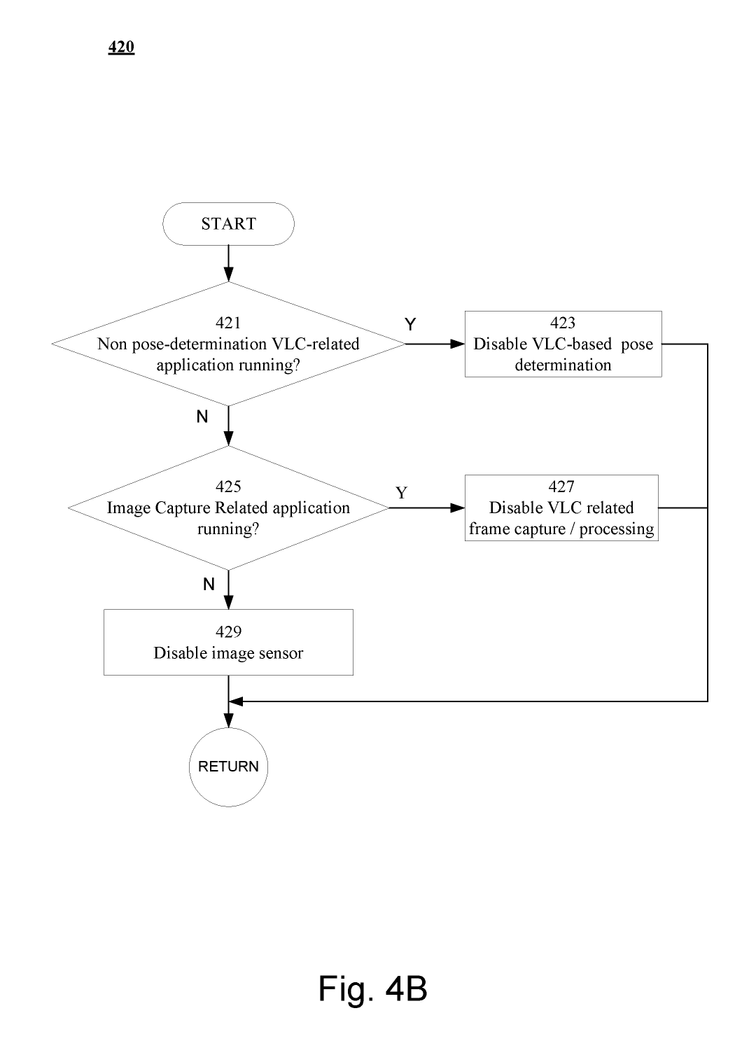

FIG. 4A shows a flowchart of an exemplary method 400 for power efficient VLC signal processing. In some embodiments, method 400 may be performed by UE 100 and/or processor(s) 150.

In block 405, one or more image frames with VLC information may be captured. For example, processor(s) 150 may initiate the capture one or more image frames, which may include VLC information, through image sensor 110.

In block 407, if the current pose of UE 100 is known (“Y” in block 407), then, block 410 may be invoked. If the current pose of UE 100 is not known (“N” in block 407), then, block 455 may be invoked, where a pose of UE 100 may be determined.

In block 410, a motion state of UE 100 may be determined. For example, the motion state of UE 100 may be determined based on input provided by motion sensor 130 and/or MDSP (e.g. via motion detection signal 340-1) and/or based on a motion state based on a prior VLC pose determination (e.g. via motion detection signal 340-2 from VLC Processor 157). For example, VLC processor 157 may process VLC data in VLC image frames that are processed to determine a change in position over some time period and provide an indication of the degree of motion to ISP 155.In some embodiments, the motion state of UE 100 may also be determined based on input provided by a device communicatively or operatively coupled to UE 100 such as a pedometer, activity tracker etc. In some embodiments, the motion state may include information indicating whether UE is stationary, undergoing rotational movement only (without displacement), undergoing displacement only (no rotation), or some combination of rotation and displacement. In some embodiments, motion state detection signal 340 may also indicate a speed (rate of change of position) and/or an angular speed (rate of change of orientation) of UE 100, and/or whether UE 100 is moving at a speed or angular speed above some threshold. In some embodiments, the threshold may be predetermined, set by default, and/or user configurable. In some embodiments, motion detection signal may comprise some or all of the motion state information.

In block 415, if UE 100 is determined to be stationary (“Y” in block 415), then, block 420 may be invoked and VLC pose determination may be disabled. In some embodiments, in block 415, UE 100 may also be considered to be stationary when the speed is below a first threshold and the angular speed is below a second threshold. Block 420 is described further in FIG. 4B below. After performing functions in accordance with block 420 where VLC pose determination may be disabled, another iteration may be commenced in block 410.

In block 415, if UE 100 is not determined to be stationary (“N” in block 415), then, in block 435, if UE 100 is determined to be undergoing rotational movement only (no displacement) (“Y” in block 435), then, block 440 may be invoked and VLC position determination may be disabled. In some embodiments, VLC orientation determination may continue to be performed. For example, UE 100 may continue to determine orientation based on received VLC signals and measured AoA information from one or more of the VLC sources. Another iteration may then be commenced in block 410.

In block 435, if UE 100 is not determined to be undergoing only rotational movement (“N” in block 435), then, in block 445, if UE 100 is determined to be undergoing displacement only (no rotation) (“Y” in block 445), then, block 450 may be invoked and VLC orientation determination may be disabled. In some embodiments, VLC position determination may continue to be performed. For example, UE 100 may continue to determine orientation based on received VLC signals and measured information from one or more of the VLC sources. Another iteration may then be commenced in block 410.

In block 445, if UE 100 is not determined to be undergoing only displacement (“N” in block 445), then, in block 455, normal VLC frame processing and/or pose determination may be performed and/or resumed. In block 455, UE 100 is determined to be undergoing both rotation and displacement. For example, UE 100 may continue to determine pose based on received VLC signals and measured information from one or more of the VLC sources. Another iteration may then be commenced in block 410.

In some embodiments, method 400 may be interrupted and may default to block 455, when the user initiates an emergency call (e.g. 911 in the US), or initiates a call to one or more designated numbers, or starts some designated applications. In some embodiments, method 400 may be interrupted and may default to block 455 when the user receives a call from one or more designated numbers (or entities associated with those numbers).

FIG. 4B shows a flowchart illustrating an exemplary method 420 of disabling VLC based pose determination. In some embodiments, in block 421, it may determined if a non pose-determination VLC-related application is running on UE 100. For example, an application may be receiving other data from VLC sources (e.g. unrelated to pose determination).

If a non pose-determination VLC-related application is running (“Y” in block 421), then, in block 423, VLC pose determination may be disabled and control may return to the calling routine. However, VLC frame processing for the other (non pose-determination) VLC application(s) may continue.

If a non pose-determination VLC-related application is not running (“N” in block 421), then, in block 425, it may be determined if an image capture or other application that uses image sensor 110 on UE 100 is running

If an image capture application and/or another application that uses image sensor 110 is running (“Y” in block 425), then, in block 427, VLC related image capture and/or VLC related frame processing may be selectively disabled and control may return to the calling routine. In some embodiments, VLC related processing of one or more captured frames may be skipped. For example, where a rolling shutter is used with image sensor 110, ISP 155 may stop processing lines for skipped frames. In some embodiments, VLC related frame processing and/or storage may be disabled. For example, ISP 155 may not: (i) write VLC related frames to memory and/or (ii) send VLC related data to VLC processor 157.

In some embodiments, frames may not be captured for VLC processing but may continue at an appropriate frame rate in accordance with the application using image sensor 110. For example, when video is being captured, processing of one or more frames may be skipped and processing may occur at the normal video frame rate (e.g. 30 fps instead of 240 fps).

If an image capture application and/or another application that uses image sensor 110 is not running (“N” in block 425), then, in block 429, image sensor 110 may be disabled and control may return to the calling routine. In some embodiments, the image sensor may be powered off, or placed into a low power or sleep mode. In some embodiments, the image sensor may be powered off for some specified time period.

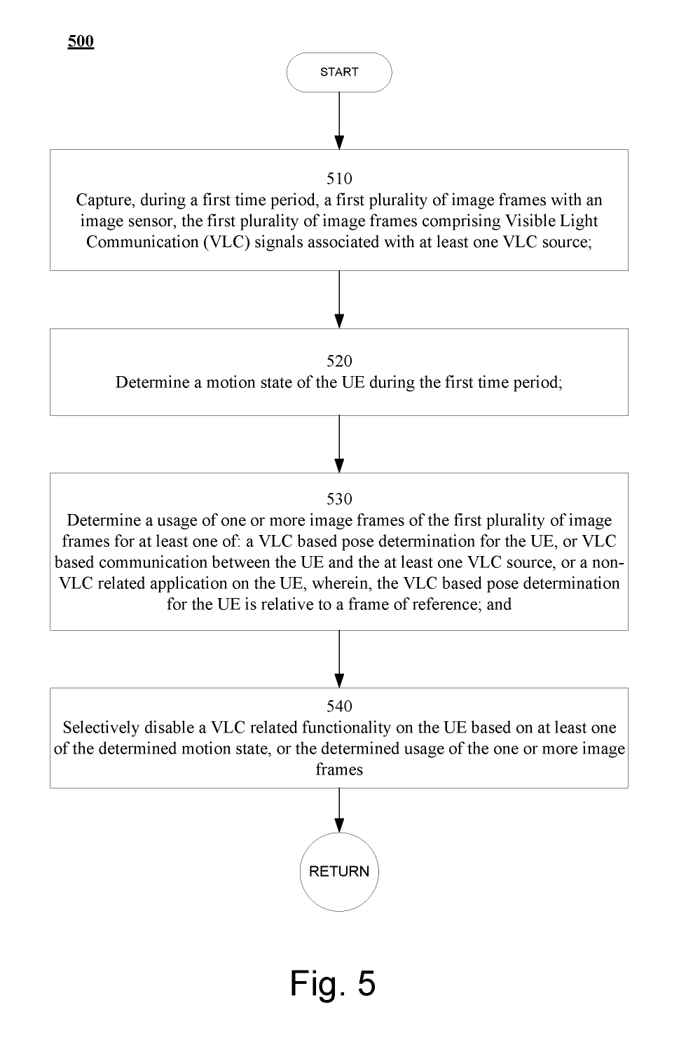

FIG. 5 shows a flowchart of an exemplary method 500 for power efficient VLC signal processing. In some embodiments, method 500 may be performed by UE 100 and/or processor(s) 150.

In block 510, during a first time period, a first plurality of image frames may be captured with the at least one image sensor. The first plurality of image frames may comprise Visible Light Communication (VLC) signals associated with at least one VLC source. For example, processor(s) 150 may initiate the capture one or more image frames, which may comprise VLC information, through image sensor 110.

In block 520, a motion state of the UE during the first time period may be determined. In some embodiments, determining the motion state of the UE during the first time period may comprises: determining the motion state of the UE based on at least one of: input from a motion sensor on the UE; or relative motion of the at least one VLC source relative to the image sensor; or a combination thereof.

For example, the motion state of UE 100 may be determined based on input provided by motion sensor 130 and/or MDSP (e.g. via motion detection signal 340-1) and/or based on a motion state based on a prior VLC pose determination (e.g. via motion detection signal 340-2 from VLC Processor 157). For example, VLC processor 157 may process VLC data in VLC image frames that are processed during the first time period to determine a change in position over the first time period and provide an indication of the motion state.

In some embodiments, the motion state of UE 100 may also be determined based on input provided by a device communicatively or operatively coupled to UE 100 such as a pedometer, activity tracker etc.

In some embodiments, the motion state may include information indicating whether UE is stationary, undergoing rotational movement only (without displacement), undergoing displacement only (no rotation), or some combination of rotation and displacement. In some embodiments, motion state detection signal 340 may also indicate a speed (rate of change of position) and/or an angular speed (rate of change of orientation) of UE 100, and/or whether UE 100 is moving at a speed or angular speed above some threshold. In some embodiments, the threshold may be predetermined, set by default, and/or user configurable. In some embodiments, motion detection signal 340 may comprise some or all of the motion state information.

In block 520, a usage of one or more image frames of the first plurality of image frames may be determined. In some embodiments, it may be determined if the one or more image frames are being utilized for at least one of: (a) a VLC based pose determination for the UE relative to a frame of reference, or (b) VLC based communication between the UE and the at least one VLC source, or (c) a non-VLC related application on the UE.

In some embodiments, the pose of the UE may be determined in 6 DOF and the VLC based pose determination for the UE may comprise a VLC based location (e.g. (X, Y, Z) coordinates) determination for the UE and a VLC based orientation (e.g. (φ, θ, ψ) coordinates) determination for the UE relative to the frame of reference. The pose of the UE may be determined in 6 DOF.

In block 530, VLC related functionality on the UE may be selectively disabled based on at least one of the determined motion state, and/or the determined usage of the one or more image frames.

For example, when the motion state of the UE indicates UE rotational motion at a location of the UE during the first time period and the location of the UE is known, selectively disabling the VLC related functionality on the UE may comprise disabling the VLC based location determination for the UE. In some embodiments, the method may further comprise: detecting a change in the motion state, wherein the change in the motion state indicates a displacement of the UE; and enabling the VLC based location determination.

As another example, when the motion state of the UE indicates displacement of the UE without a change in orientation of the UE during the first time period and the orientation of the UE is known, selectively disabling the VLC related functionality on the UE may comprise disabling the VLC based orientation determination for the UE. In some embodiments, the method may further comprise: detecting a change in the motion state, wherein the change in the motion state indicates a change in orientation of the UE; and enabling the VLC based orientation determination.

As a further example, when the motion state of the UE indicates that the UE is stationary during the first time period and the pose of the UE is known, selectively disabling the VLC related functionality on the UE may comprise: disabling the VLC based pose determination. In some embodiments, the method may further comprise: detecting a change in the motion state, wherein the change in the motion state indicates that the UE is not stationary; and enabling the VLC based pose determination.

In some embodiments, when the motion state of the UE indicates that the UE is stationary during the first time period, selectively disabling the VLC related functionality on the UE may comprise at least one of: disabling a VLC signal demodulation function on the UE, or disabling a VLC frame processing function on the UE. In some embodiments, disabling the VLC frame processing function may comprise: disabling a storage of one or more VLC image frames. In some embodiments, the method may further comprise: detecting a change in the motion state, wherein the change in the motion state indicates that the UE is no longer stationary; and activating at least one of the VLC signal demodulation function or the VLC frame processing function on the UE.

In some embodiments, when the motion state of the UE indicates that the UE is stationary during the first time period, selectively disabling the VLC related functionality on the UE may comprise disabling the image sensor, upon a determination that the UE is not communicating with at least one VLC source and that the image sensor is not being utilized by another application on the UE. In some embodiments, the method may further comprise: detecting a change in the motion state, wherein the change in the motion state indicates that the UE is no longer stationary; and activating the image sensor.

In some embodiments, normal VLC processing may be initiated at any time when the user places: (i) an emergency call, or (ii) a call to one or more designated telephone numbers (or entities associated with those numbers). In some embodiments, normal VLC processing may also be initiated when the user receives a call from one or more designated numbers (or entities associated with those numbers). Thus, in some embodiments, selective disabling of VLC related functionality may be suspended when the user places a call to or receives a call from one or more designated entities/numbers and/or starts designated applications on UE 100.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method on a User Equipment (UE) comprising an image sensor, the method comprising:
capturing, during a first time period, a first plurality of image frames with the image sensor, the first plurality of image frames comprising Visible Light Communication (VLC) signals associated with at least one VLC source;
determining a motion state of the UE during the first time period;
determining a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and
selectively disabling a VLC related functionality on the UE based on at least one of the determined motion state, or the determined usage of the one or more image frames.

2. The method of claim 1, wherein:
the VLC based pose determination for the UE comprises a VLC based location determination for the UE and a VLC based orientation determination for the UE.

3. The method of claim 2, wherein:
the motion state of the UE indicates UE rotational motion at a location of the UE during the first time period, and,
selectively disabling the VLC related functionality on the UE comprises:
disabling the VLC based location determination for the UE, when the location of the UE is known.

4. The method of claim 3, further comprising:
detecting a change in the motion state of the UE during a second time period, wherein the change in the motion state of the UE indicates a displacement of the UE; and
enabling the VLC based location determination.

5. The method of claim 1, wherein:
the motion state of the UE indicates that the UE is stationary during the first time period, and,
selectively disabling the VLC related functionality on the UE comprises at least one of:
disabling a VLC signal demodulation function on the UE, or
disabling a VLC frame processing function on the UE.

6. The method of claim 5, further comprising:
detecting a change in the motion state of the UE during a second time period, wherein the change in the motion state of the UE indicates that the UE is no longer stationary; and
activating at least one of the VLC signal demodulation function or the VLC frame processing function on the UE.

7. The method of claim 1, wherein:
the motion state of the UE indicates that the UE is stationary during the first time period, and,
selectively disabling the VLC related functionality on the UE comprises:
disabling the image sensor, upon a determination that the UE is not communicating with the at least one VLC source and that the image sensor is not being utilized by another application on the UE.

8. The method of claim 7, further comprising:
detecting a change in the motion state of the UE during a second time period, wherein the change in the motion state of the UE indicates that the UE is no longer stationary; and
activating the image sensor.

9. A User Equipment (UE) comprising:
an image sensor,
a processor coupled to the image sensor, wherein the processor is configured to:
initiate, during a first time period, a capture of a first plurality of image frames using the image sensor, the first plurality of image frames comprising Visible Light Communication (VLC) signals associated with at least one VLC source;
determine a motion state of the UE during the first time period;
determine a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and
selectively disable a VLC related functionality on the UE based on at least one of the determined motion state, or the determined usage of the one or more image frames.

10. The UE of claim 9, wherein:
the VLC based pose determination for the UE comprises a VLC based location determination for the UE and a VLC based orientation determination for the UE.

11. The UE of claim 10, wherein:
the motion state of the UE indicates UE rotational motion at a location of the UE during the first time period, and,
to selectively disable the VLC related functionality on the UE, the processor is configured to:
disable the VLC based location determination for the UE, when the location of the UE is known.

12. The UE of claim 11, wherein the processor is further configured to:
detect a change in the motion state of the UE during a second time period, wherein the change in the motion state of the UE indicates a displacement of the UE; and
enable the VLC based location determination.

13. The UE of claim 10, wherein:
the motion state of the UE indicates that the UE is stationary during the first time period, and,
to selectively disable the VLC related functionality on the UE, the processor is configured to:
disable the VLC based pose determination.

14. The UE of claim 9, wherein:
the motion state of the UE indicates that the UE is stationary during the first time period, and,
to selectively disable the VLC related functionality on the UE, the processor is configured to perform at least one of:
disable a VLC signal demodulation function on the UE, or
disable a VLC frame processing function on the UE.

15. The UE of claim 14, wherein to disable the VLC frame processing function, the processor is configured to:
disable a storage of one or more VLC image frames.

16. The UE of claim 14, wherein the processor is further configured to:
detect a change in the motion state of the UE during a second time period, wherein the change in the motion state of the UE indicates that the UE is no longer stationary; and
activate at least one of the VLC signal demodulation function or the VLC frame processing function on the UE.

17. The UE of claim 9, wherein:
the motion state of the UE indicates that the UE is stationary during the first time period, and,
to selectively disable the VLC related functionality on the UE, the processor is configured to:
disable the image sensor, upon a determination that the UE is not communicating with the at least one VLC source and that the image sensor is not being utilized by another application on the UE.

18. The UE of claim 17, wherein the processor is further configured to:
detect a change in the motion state of the UE during a second time period, wherein the change in the motion state of the UE indicates that the UE is no longer stationary; and
activate the image sensor.

19. The UE of claim 9, further comprising:
a motion sensor coupled to the processor,
wherein, to determine the motion state of the UE during the first time period, the processor is configured to:
determine the motion state of the UE based on at least one of:
input from the motion sensor; or
relative motion of the at least one VLC source relative to the image sensor; or
a combination thereof.

20. A non-transitory computer-readable medium comprising executable instructions to configure a processor on a User Equipment (UE) with an image sensor to:
initiate, during a first time period, a capture of a first plurality of image frames with the image sensor, the first plurality of image frames comprising Visible Light Communication (VLC) signals associated with at least one VLC source;
determine a motion state of the UE during the first time period;
determine a usage of one or more image frames of the first plurality of image frames for at least one of: a VLC based pose determination for the UE, or VLC based communication between the UE and the at least one VLC source, or a non-VLC related application on the UE, wherein, the VLC based pose determination for the UE is relative to a frame of reference; and
selectively disable a VLC related functionality on the UE based on at least one of the determined motion state, or the determined usage of the one or more image frames.
